(19) United States
(12) Patent Application Publication
(10) Pub. No.: US 2008/0240032 A1
(43) Pub. Date: Oct. 2, 2008

(54) SYSTEM AND METHOD FOR CONDENSED FREQUENCY REUSE IN A WIRELESS COMMUNICATION SYSTEM

(75) Inventors: Peter Gelbman, Kirkland, WA (US); Nicolas Kauser, Kirkland, WA (US); John Saw, Sammamish, WA (US)

Correspondence Address: DAVIS WRIGHT TREMAINE, LLP/Seattle, 1201 Third Avenue, Suite 2200, SEATTLE, WA, 98101-3045, US

(73) Assignee: Clearwire Corporation, Kirkland, WA (US)

(21) Appl. No.: 12/055,169

(22) Filed: Mar. 25, 2008

Related U.S. Application Data
(60) Provisional application No. 60/908,270, filed on Mar. 27, 2007.

(51) Int. Cl. H04Q 7/00; H04K 1/10; H04Q 7/20

(52) U.S. Cl. 370/329; 375/260; 370/343; 455/452.1

(57) ABSTRACT

A legacy spectrum allocation results in inefficient use of the spectrum now allocated to broadband services. A broadband wireless OFDMA communication system allocates channels with overlap between adjacent channels to make more efficient use of the allocated spectrum. Guard tones are eliminated to reduce channel bandwidth requirements leaving a smaller bandwidth overlap. Interference mitigation procedures are used to reduce adjacent channel interference.

### BACKGROUND OF THE INVENTION

1. Field of the Invention

The present invention is directed generally to a wireless communications system and, more particularly, to a system and method for allocating spectrum and frequency reuse.

2. Description of the Related Art

Broadband wireless communications systems are increasingly employing OFDMA (Orthogonal Frequency Division Multiple Access) as the underlying radio PHY (physical layer) technology. The extensive system design advantages of OFDMA are documented extensively in existing literature. OFDMA as a general technology has a wide scope—the industry is producing several variants and configurations that seek to achieve maximum performance. IEEE 802.16e and WiMAX standards introduced a scalable OFDMA (S-OFDMA) system architecture that enables network service providers to economically address the diverse business and regulatory wireless requirements throughout the world. IEEE P802.16-2004, Standard for Local and Metropolitan Area Networks, Part 16: Air Interface for Fixed Broadband Wireless Access Systems. The scalable FFT sizes, flexible channel bandwidths, and various cellular frequency reuse schemes offered by these standards produce a remarkably agile system.

Despite these progressive technical advances, all existing strategies continue to operate within a paradigm of fixed channel bandwidths that do not always permit an operator to reach optimal spectral efficiency. Therefore, it can be appreciated that there is a significant need for a spectrum allocation strategy that increases spectral efficiency and utilization. The present invention provides this, and other advantages, as will be apparent from the following detailed description and accompanying figures.

### BRIEF DESCRIPTION OF THE SEVERAL VIEWS OF THE DRAWING(S)

FIG. 1 illustrates WiMAX System Profiles.

FIG. 2 illustrates a pre-transition Band Plan (6 MHz channels).

FIG. 3 illustrates a post-transition Band Plan (5.5 MHz channels).

FIG. 4 illustrates a condensed frequency reuse diagram.

FIG. 5 illustrates ACLR and ACS interference data.

FIG. 6 illustrates transmitter spectral emissions vs. output power.

FIG. 7 illustrates an ACP diagram.

FIG. 8 illustrates FCC spectrum test results for one configuration of a communications system.

FIG. 9 illustrates out-of-band emissions plot for a 10 MHz channel in another communications system.

FIG. 10 illustrates the 802.16e OFDMA Time Division Duplexing frame structure.

FIG. 11 illustrates FCH and DL-MAP in condensed re-use.

FIG. 12 is a diagram illustrating a wireless communication system constructed in accordance with the present disclosure.

### DETAILED DESCRIPTION OF THE INVENTION

The system described herein provides a novel spectrum allocation strategy. The examples provided herein are in the 2.5 GHz band. The invention is applicable to other portions of the spectrum. This band was previously designated as an Instructional Television Fixed Service (ITFS) and Multipoint Distribution Service (MDS) band. Under the frequency spectrum allocation originally developed by the Federal Communications Commission (FCC) the band was divided into 6 MHz channels. This portion of the spectrum today is referred to as the Educational Broadband Service (EBS)/Broadband Radio Services (BRS) spectrum. Although this portion of the spectrum is generally referred to as the EBS/BRS spectrum, it is sometimes still referred to as the ITFS/MDS spectrum.

The ITFS/MDS spectrum was originally sold in 6.0 MHz allocations by the FCC. However, this crowded portion of the spectrum was often sold in nonadjacent 6.0 MHz channels.

The ITFS/MDS (EBS/BRS) 2.5 GHz band in the United States uses 5.5 MHz channel bandwidths with unusual allocation structure that stems from the legacy analog TV designation of the band. Existing OFDMA technology standards are primarily targeting 5 and 10 MHz channels that do not fit into this spectrum neatly. Ideally the standards will evolve to support this band more efficiently, but that will require lengthy ratification processes and ultimately costly hardware and software changes to many existing commercial equipment.

This document describes a method for deploying 10 MHz WiMAX channels using overlapping channels and a novel reuse strategy which is capable of providing significant benefits over existing channel spacing and reuse schemes. This method enables flexible system configurations that maximize spectral efficiency for OFDMA systems operating in the EBS/BRS 2.5 GHz spectrum.

IEEE 802.16e and WiMAX specify several types of physical layers for different frequency bands and system applications, and allows for both Time-Division Duplexing (TDD) and Frequency-Division Duplexing (FDD) operation. The layers referred to herein are part of the ISO/OSI model. The physical (PHY) layer refers to the lowest layer in the ISO/OSI model that describes hardware connections between devices.

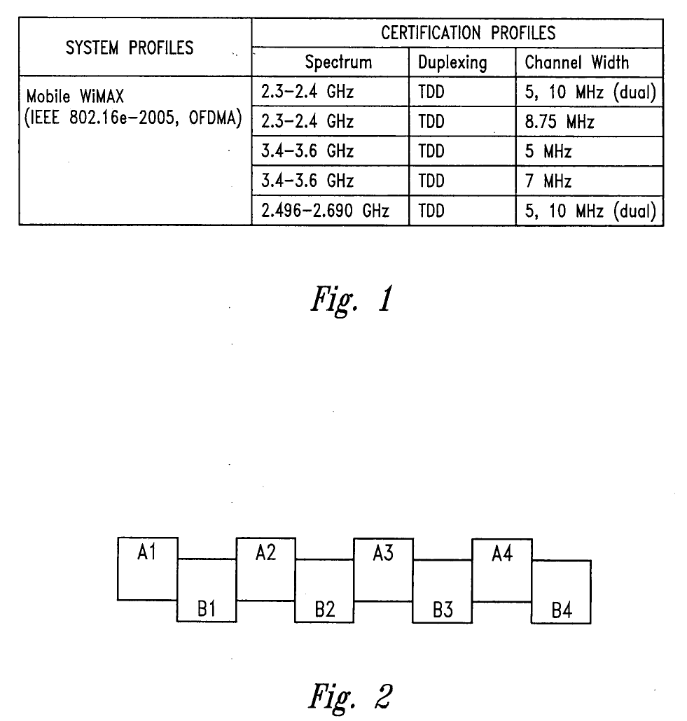

Currently, the industry is largely focusing on the OFDMA PHY, TDD version for Point to Multi-point (PMP) mobile networks below 11 GHz. IEEE P802.16-2005, February 2006, Standard for Local and Metropolitan Area Networks, Part 16: Air Interface for Fixed Broadband Wireless Access Systems, Amendment for Physical and Medium Access Control Layers for Combined Fixed and Mobile Operation in Licensed Bands and Corrigendum 1. The WiMAX Forum has produced the concept of standardized system profiles for TDD systems, depicted in the figure below. PHY supports channel bandwidths of 20 MHz, 10 MHz, 5 MHz, and 2.5 MHz, with scalable FFT sizes of 2048, 1024, 512, and 128, respectively. Various OFDMA subcarrier permutations schemes are specified. FIG. 1 illustrates a number of WiMAX system profiles that include other bandwidths as well. The present disclosure discusses the WiMAX OFDMA TDD PHY using 5 and 10 MHz channels in the 2.496-2690 GHz band, using PUSC (Partial Usage of Subchannels). The concepts presented here may be applied to any OFDMA system; various other implementations are possible.

OFDMA Interference Averaging

OFDMA Basics

OFDM uses many narrowband subcarrier frequencies to form a single broadband channel. An OFDM system takes a data stream and splits it into N parallel data streams, each at a rate of 1/Nth the original data rate. Each stream is then mapped onto a unique subcarrier tone. All the subcarriers are combined into a composite time domain signal for transmission. The OFDM receiver uses a time and frequency synchronized FFT to convert the OFDM time waveform back into the frequency domain. In this process the FFT picks up discrete frequency samples, corresponding to just the peaks of the carriers. At these frequencies, all other carriers pass through zero amplitude eliminating any interference between the subcarriers. OFDM subcarriers have a sinc (sin(x)/x) frequency response resulting in overlap in the frequency domain. This overlap does however not cause any interference due to the orthogonality of the subcarriers. These concepts are discussed in WIMAX Nuts and Bolts: An Introduction to the IEEE 802.16e Standard, S. Hilton, Motorola, Inc., Mar. 3, 2006.

The WiMAX 802.16e OFDMA PHY uses a technique known as subchannelization, which partitions the OFDM subcarrier tones into groups which form logical subchannels and encodes symbols onto the subchannels. WiMAX subchannelization is referred to as OFDMA (Orthogonal Frequency Division Multiple Access) because the subchannels provide a mechanism to multiplex symbols to multiple subscribers in each frame. These subchannels are dynamically allocated among all users on a continuous basis, according to bandwidth requirements.

Interference Mitigation Strategies

The two basic and vital requirements for any efficient cellular system are:
Avoid/minimize intra-cell interference (co-channel, within the cell).
Avoid/average inter-cell interference (co-channel and adjacent-channel, neighboring cells).

There are three primary categories of techniques to manage interference in cellular radio systems:

### 1. Interference Avoidance

Detect and avoid—i.e. Carrier Sense Multiple Access (CSMA) as with Ethernet
Frequency planning
Power control
Resource coordination
   Timeslot allocation as in TDMA
   Multi-dimensional MAC scheduling

### 2. Interference Averaging

Orthogonal codes such as CDMA
Frequency diversity spreading, example 802.16e PUSC subchannelization
   3. Interference mitigation/cancellation—smart antennas, or multi-antenna signal processing (MAS)
Receive/transmit diversity and combining techniques to provide signal-to-noise-ratio (SNR) gains. Examples include Alamouti Space-Time-Codes (STC) and Maximum Ratio Combining (MRC).
Interference rejection techniques to provide signal-to-noise+interference (SINR) gains. Examples include adaptive spatial filtering, active beam/null steering.
Spatial Multiplexing—coherent processing to resolve multiple discreet information streams from the same radio channel in different physical space. Examples include spatial division multiple access (SDMA) and MIMO.

Virtually all cellular radio technologies have employed one or more of the above interference mitigation techniques and are typically able to achieve one of the two primary cellular design requirements. No existing mainstream cellular technology achieves both of the requirements completely.

The WiMAX OFDMA system uses all three interference mitigation techniques (avoidance, averaging, and mitigation/cancellation): frequency planning, power control, advanced resource scheduling, interference averaging, and several multi-antenna signal processing strategies. OFDM subchannelization introduces a paradigm shift for managing cellular RF interference. WiMAX system design is seeking to achieve maximum spectral efficiency by utilizing all these interference mitigation techniques in concert to achieve both of the primary system design goals: minimize both intra-cell and inter-cell interference.

### OFDMA Subchannelization, Permutations and Interference Averaging

The core purpose of WiMAX subchannelization is the mitigation of inter-cell (co-channel and adjacent-channel) interference through averaging. Those skilled in the art will appreciate that OFDM technology establishes a broadband channel using many narrow band carriers or tones. The process of multiple access using OFDMA subdivides the tones into groups allocated to different users. This technology is well known in the art and need not be described in greater detail herein. Those skilled in the art having a knowledge of WiMAX will also appreciate that groups of tones are referred to as “subchannels.” WiMAX has many different approaches to OFDMA. Among these are PUSC, FUSC, and AMC. Each of these approaches is known in the art and will not be described in greater detail herein.

The WiMAX frame structure specifies PUSC as the mandatory zone and several optional zones such as FUSC, AMC, etc. Each zone has a slightly different mechanism for allocating the subchannel tones, which create slightly different optional systematic approaches for management of interference in the network—that topic is beyond the scope of this document. This section focuses only on the mandatory PUSC zone to illustrate the general concept interference averaging. In the WiMAX PUSC zone, the allocation of OFDM tones is a dynamic, randomized scheme that varies the subcarriers according to a unique permutation code. Each user's traffic is “spread” across a range of constantly changing subsets of the OFDM tones, producing a high degree of statistical frequency diversity in the system.

As in any cellular system, a base station (BS) has a plurality of sectors that will have overlapping areas of RF coverage where some subscriber's channels will collide with others; this traditionally creates “pockets” of high co-channel interference, which can be measured as a carrier to interference (C/I) ratio. In the OFDMA system, among co-channel and adjacent-channel PUSC subscribers on neighboring cells within in a system, the chances that the specific pattern of tones that comprise one user's subchannel on one sector will coherently interfere with another user on the same or adjacent channel on a nearby sector at the same time are greatly minimized. In this manner inter-cell interference is statistically averaged to lower levels for all users.

### EBS/BRS Spectrum

As previously discussed, the ITFS/MDS spectrum was originally allocated in 6.0 MHz blocks. Following the transition to the EBS/BRS spectrum, the channel allocation and usage was altered, as described below. In markets under the pre-transition 6 MHz channel plan, spectrum is typically allocated in interleaved blocks, of four 6 MHz channels. For example, an A and B block are shown in FIG. 2. Each block (e.g., block A1) comprises four 6 MHz channels. Under the old plan, one of those four channels was designated as a special purpose high-power channel that was not available for general use.

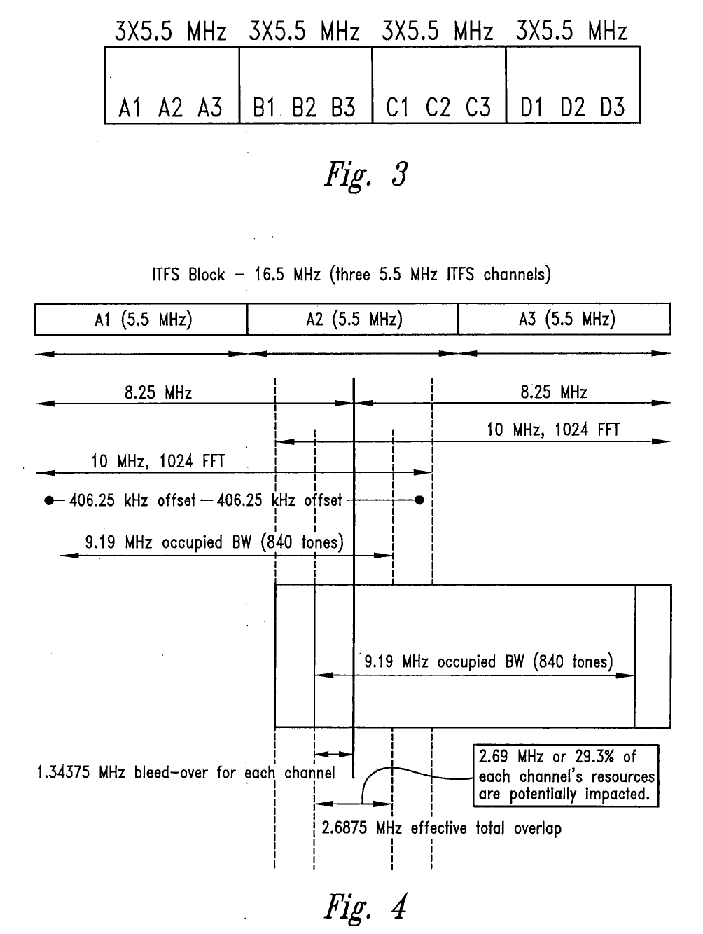

In markets under the post-transition 5.5 MHz plan, three of the channels are reduced to 5.5 MHz bandwidth and relocated to form a contiguous block of spectrum. The fourth channel (i.e., the special purpose high-power channel) remains at 6 MHz of bandwidth and is relocated to a portion of the band set aside for high power video operation. The newly formed block of 16.5 MHz is comprised of three 5.5 MHz channels and is intended for cellular deployments such as WiMAX. An example, A, B, C, and D blocks are shown in FIG. 3. In this example, A1 is 5.5 MHz, A2 is 5.5 MHz, and A3 is 5.5 MHz, thus forming a 16.5 MHz contiguous block.

### WIMAX Channel Bandwidth and Reuse Configurations

Channel Bandwidth

The WiMAX standards support various channel bandwidths. In the USA, these are 5, 10, 15, and 20 MHz. For practical implementations, both the 5 and 10 MHz channel bandwidths are currently being considered.

Frequency Reuse

WiMAX re-use terminology uses the following format:

### BTS/Sector/Channel

WIMAX standards promote two primary re-use schemes:

1/3/3 (1 BTS, 3 sectors, 3 channel)—re-use 3

1/3/1 (1 BTS, 3 sectors, 1 channel)—re-use 1

The terminology used herein refers to the base station, number of sectors, and number of channels (i.e., frequencies) of operation. For example, the designation 1/3/3 refers to a BTS having 3 sectors and 3 channels. Under this designation, each sector has its own channel or frequency of operation. In contrast, the designation 1/3/1 refers to a single base station with 3 sectors and only 1 channel. Under this scheme, each of the 3 sectors utilizes the same channel or frequency of operation.

A 1/3/1 configuration has reduced performance compared to 1/3/3 due to increased interference, but depending on load distribution can take advantage of increased peak throughputs via statistical multiplexing of traffic.

Default System Configuration Options

This section describes how a WiMAX OFDMA PUSC 1/3/3 system using 5 and 10 MHz channels may operate within the EBS/BRS band, using existing reuse strategies. Two 5 MHz systems can be said to provide equal bandwidth to one 10 MHz system, however in reality, the 10 MHz configuration offers significant benefits with regard to peak subscriber data rates and protocol efficiencies—thus 10 MHz is preferred.

### 5 MHZ Channel Configuration

Three 5 MHz channels in a 1/3/3 reuse scheme could be used in each 16.5 MHz EBS/BRS block. For capacity equal to a 10 MHz system, two blocks (6 channels, 33 MHz) would be required. These could be utilized for maximum capacity by extending the re-use scheme to 1/3/6, or in a stacked site/sector configuration (2 overlaid 5 MHz 1/3/3 systems). In either configuration, a total of six 5 MHz channels in the available six 5.5 MHz channel allocations results in 1.5 MHz unused bandwidth for each block, wasting a total of 3 MHz.

### 10 MHz Channel Configuration

Alternatively, 10 MHz channels could be used in a single 1/3/3 configuration. Each 10 MHz channel would require two 5.5 MHz channels out of each 16.5 MHz block. Since a total of 30 MHz is required for three channels, there are two potential ways to achieve this configuration:
a) One possible configuration would require two sets of adjacent EBS/BRS blocks, 33 MHz spectrum total. In this configuration, three 10 MHz channels could be made up of three paired (adjacent) 5.5 MHz channels. Under this configuration, each 10 MHz channel would be formed out of two 5.5 MHz paired channels resulting in 1 MHz unused bandwidth for each 11 MHz of spectrum. For three 10 MHz channels, this again wastes a total of 3 MHz. More importantly, 2.5 GHz operators may not have 2 adjacent blocks in every market.
b) Alternatively, three sets of non-adjacent EBS/BRS blocks could be used, 49.5 MHz of spectrum total. In this configuration, each 10 MHz channel could be made up of two adjacent 5.5 MHz channels out of each block. This would use only 10 MHz out of every 16.5 MHz block, leaving 6.5 MHz unused for each block, or 19.5 MHz total unused. Clearly this is a massive waste of spectrum. Also, operators may not have this amount of spectrum available in every market.

Summary: Using default WiMAX 1/3/3 reuse, 5 MHz channels in any 1/3/3 configuration leaves 3 MHz or 9% wasted spectrum. The best case 10 MHz 1/3/3 configuration also results in at least 3 MHz or 9% wasted spectrum. The 10 MHz channel configuration is by far the preferred deployment, but may not be feasible due to lack of adjacent blocks or lack of total required amount of spectrum.

### Condensed Frequency Reuse Proposal

The concept is to fully leverage the many advanced interference mitigation techniques of WIMAX, namely OFDMA interference averaging to permit overlapping 10 MHz channels and facilitate a 4 channel reuse scheme. As will be described in greater detail below, the 16.5 MHz can be allocated to four 5.0 MHz channels. However, in many system implementations 10.0 MHZ channels are desired. In systems where each BS uses three sectors, three channels are required for a 1/3/3 reuse scheme. Implementation of 10.0 MHz channels in a 1/3/3 reuse scheme requires two blocks of 16.5 MHz (a total of 33.0 MHz). In a 1/3/3 reuse scheme, three of the four 10.0 MHz channels are used for the three sectors. The fourth 10.0 MHz channel can be used to provide coverage for “hot spots,” thus providing a 1/3/4 reuse scheme. Alternatively, each BS can be divided into four sectors thus providing a 1/4/4 reuse scheme that utilize all four of the 10.0 MHz channels.

The 33 MHz of total spectrum is fully utilized by allowing each pair of 10 MHz channels to overlap within a 16.5 MHz portion of the spectrum. A 1/3/4 or 1/4/4 configuration would be created by running two 10 MHz channels in each EBS/BRS block, creating a total of four 10 MHz channels out of two 16.5 MHz blocks that do not have to be adjacent. For example, the blocks A1-A3 and C1-C3 could be used to provide the four 10.0 MHz channels if those non-adjacent blocks are all that are available to a service provider in a particular geographic region.

System Configuration & Impact Analysis

The following sections analyze the proposed configuration in detail. The table below summarizes 802.16e OFDMA system parameters for both 5 and 10 MHz systems that will be used for calculations in the following sections.

| | 5 MHz | 10 MHz |
|---|---|---|
| Frequency | 2.5 GHz | 2.5 GHz |
| Frequency re-use scheme | 1/3/3 | 1/3/3 |
| Permutation Scheme | PUSC | PUSC |
| Frame Duration (ms) | 5 | 5 |
| FFT size | 512 | 1024 |
| Frame Duration (symbols) | 48.61 | 48.61 |
| Cyclic Prefix-% symbol | .125 | .125 |
| duration | | |
| Total Symbol Duration (us) | 102.86 | 102.86 |
| Useful Symbol Duration (us) | 91.43 | 91.43 |
| Inter-Carrier Spacing (kHz) | 10.9375 | 10.9375 |
| Total Subcarriers | 512 | 1024 |
| Guard Subcarriers (left) | 46 | 92 |
| Guard Subcarrier (right) | 46 | 92 |
| Used Subcarriers | 420 | 840 |
| Pilot Subcarriers | 60 | 120 |
| Data Subcarriers | 360 | 720 |
| Downlink Subchannels | 15 | 30 |
| Uplink Subchannels | 17 | 35 |

Looking at the 10 MHz channel, we see that there are a total of 1024 tones (subcarriers). At each end of the 10 MHz channel there are 92 guard tones resulting in a total of 184 unused tones per 10 MHz channel. These guard tones are not actually transmitted, leaving 840 tones available for use. The actual occupied bandwidth of a 10 MHz channel is calculated by multiplying the inter-carrier-spacing by the number of used subcarriers:

10.9375/1000×840=9.1875

->Total occupied bandwidth of a 10 MHz channel=9.1875 MHz

The diagram of FIG. 4 illustrates the basic layout of the proposed. This example shows two overlapping channels within a single 16.5 MHz ITFS “A” block utilizing center frequencies derived from conventional 10 MHz planning.

Basically, we are dividing our 16.5 MHz of spectrum up into two 8.25 MHz channels, and “stuffing” the actual 9.1875 MHz occupied spectrum of a 10 MHz channel into each one. Obviously there will be overlap. The actual impact of the overlap depends on many configuration and deployment factors, with various considerations and tradeoffs. The following sections provide detailed analysis of these issues.

System Engineering Perspectives

Spectrum “Usability” Analysis

The diagram in FIG. 4 shows a configuration where the center frequencies of WiMAX channels are chosen such that the outer edges of each 10 MHz channel are aligned with the respective outer edges of the 16.5 MHz EBS/BRS block. This configuration naturally uses up all available spectrum in the block, while minimizing overlap region of the two channels. We calculate the overlap as follows:

First, we calculate the amount of guard band spectrum utilized on each end of a 10 MHz channel. This amount is the “offset” where the edge of the occupied channel bandwidth starts in from the edge of the EBS/BRS block. We'll call this the “occupied bandwidth offset”:

10−9.1875=0.8125

0.8125/2=0.40625

So within the context of a 10 MHz WiMAX channel, the actual guard bandwidth at each channel edge is 406.25 kHz.

Next, we calculate the difference of occupied spectrum of one 10 MHz channel vs. the 8.25 MHz we have available from half of a 16.5 MHz EBS/BRS block. We'll call this the “occupied bandwidth delta”:
16.5/2=8.25
9.1875−8.25=0.9375

Finally, we add the “occupied bandwidth offset” and the “occupied bandwidth delta”:
0.40625+0.9375=1.34375

This means that a single 10 MHz channel will overlap into the other by 1.34375 MHz. Since we have two channels overlapping simultaneously, the total overlap region that is felt by both channels is:
1.34375×2=2.68750

This means that 2.68750 MHz worth of each WiMAX channel in a single EBS/BRS block would potentially experience interference from the other. Normally, a 10 MHz WiMAX channel has an actual occupied bandwidth of 9.1875 MHz. The above calculation shows that the amount of occupied bandwidth that is potentially affected by the overlap proposal is 29.3% (2.6875/9.1875=0.2925).

However, since the proposed scheme permits 4 channels in 33 MHz of spectrum as compared to 3, we actually realize a 23% increase in spectrum usage for markets with non-adjacent 16.5 MHz EBS/BRS block allocations, and only 5% reduction compared to the best-case default WiMAX reuse schemes using in markets with adjacent 16.5 MHz EBS/BRS blocks. Further, such a configuration would permit a mature network to realize the benefits of running 10 MHz channels (higher user peak data rates, single bandwidth devices, etc) while achieving maximum spectral efficiency with 33% less sectors than the maximum possible 5 MHz system.

To illustrate these issues, the following section shows a comparison of the various WiMAX 1/3/3 reuse deployment options in 5 and 10 MHz channels and the proposed 10 MHz condensed reuse 1/3/4 and 1/4/4 plans. We define a summary metric called “total spectral usability” which is the ratio of actual occupied bandwidth and total used spectrum.

### Default WiMAX 5 MHz 1/3/3 Scheme (2 Non-Adjacent ITFS Blocks)

ITFS/MDS (EBS/BRS) blocks used: 2

Total spectrum used: 33.0 MHz

Total channels available in 33 MHz: 6

Total Subcarriers: 512

Total Guard Carriers: 92 (46×2)

Used Subcarriers: 420

Occupied Bandwidth: 4.59 MHz (10.9375/1000×420=4.59375)

Total Occupied Bandwidth: 27.56 MHz (4.59375×6=27.56250)

Total spectral usability: 84% (27.56250/33.0=0.8352)

Number of sectors per site: 6

### Default WiMAX 10 MHz 1/3/3 Scheme (2 Adjacent ITFS Blocks)

ITFS/MDS (EBS/BRS) blocks used: 2

Total spectrum used: 33.0 MHz

Total channels available in 33 MHz: 3

Total Subcarriers: 1024

Total Guard Carriers: 184 (92×2)

Used Subcarriers: 840

Occupied Bandwidth: 9.19 MHz (10.9375/1000×840=9.1875)

Total Occupied Bandwidth: 27.56 MHz (9.1875×3=27.56250)

Total spectral usability: 84% (27.56250/33.0=0.8352)

Number of sectors per site: 3

### Default WiMAX 10 MHz 1/3/3 Scheme (3 Non-Adjacent ITFS Blocks)

ITFS/MDS (EBS/BRS) blocks used: 3

Total spectrum used: 49.5 MHz

Total channels available in 49.5 MHz: 3

Total Subcarriers: 1024

Total Guard Carriers: 184 (92×2)

Used Subcarriers: 840

Occupied Bandwidth: 9.19 MHz (10.9375/1000×840=9.1875)

Total Occupied Bandwidth: 27.56 MHz (9.1875×3=27.56250)

Total spectral usability: 56% (27.56250/49.5=0.5568)

Number of sectors per site: 3

### Proposed 10 MHz 1/314 Scheme (2 Non-Adjacent ITFS Blocks)

ITFS/MDS (EBS/BRS) blocks used: 2

Total spectrum used: 33.0 MHz

Total channels available in 33 MHz: 4

Total Subcarriers: 1024

Total Guard Carriers: 184 (92×2)

Used Subcarriers: 840

Occupied Bandwidth (Worst Case): 6.50 MHz (9.1875−2.6875=6.50)

Total Occupied Bandwidth: 26.0 MHz (6.50×4=26.0)

Total spectral usability: 79% (26.0/33.0=0.7878)

Number of sectors per site: 3

### Proposed 10 MHz 1/414 Scheme (2 Non-Adjacent ITFS Blocks)

ITFS/MDS (EBS/BRS) blocks used: 2

Total spectrum used: 33.0 MHz

Total channels available in 33 MHz: 4

Total Subcarriers: 1024

Total Guard Carriers: 184 (92×2)

Used Subcarriers: 840

Occupied Bandwidth (Worst Case): 6.50 MHz (9.1875−2.6875=6.50)

Total Occupied Bandwidth: 26.0 MHz (6.50×4=26.0)

Total spectral usability: 79% (26.0/33.0=0.7878)

Number of sectors per site: 4

The above analysis uses 2.6875 MHz as the per-channel overlap reduction—this represents a very conservative, “worst-case” scenario. In reality, the increased interference due to overlap would only be felt at cell edges of sectors utilizing the overlapping channels. There are several methods to deploy 4 channels in the network, all of which may be optimized to minimize the actual regions in the network where the overlap interference would exist.

Further, the overlap situation should only cause the full impact under heavy load. Because WiMAX OFDMA subchannelization offers interference averaging benefits and MAC schedulers will allocate subchannel channel resources based on channel conditions and QoS requirements—the actual impact of this overlap will be far less for much of the time and certainly on networks that are not fully loaded. These issues are discussed in greater detail below.

Interference, PUSC and MAC Scheduling Benefits

The factors that determine actual interference levels experienced by real world OFDMA systems are very diverse. The following list shows some of the many factors that need to be considered:
Transmitter out of band and spurious emission levels
Transmitter linearity
Receiver selectivity
Receiver blocking performance
Net filter discrimination
Regulatory power limitations
Antenna discrimination (BS-to-BS interference)
Antenna discrimination (BS-to-SS/SS-to-BS interference)
Antenna azimuths & polarizations
Specific channel bandwidths
Power control
Smart antenna implementations, Active interference cancellation techniques
Physical BS and MS locations
Traffic patterns of the mobile subscribers
OFDMA subchannel allocations
Shielding techniques,
Frequency planning
Inter-operator cooperation and coordination
TDD synchronization
BS and MS antenna location coordination

System level simulations can be performed to understand the impact of some of these issues; however the most advanced simulation platform in the world cannot possibly capture all these elements. In light of this, at a high level we can simply state that interference in any OFDMA deployment is a highly dynamic and multi-dimensional issue.

The previous sections described the bandwidth overlap impact from a worst-case interference perspective, as if the overlapping OFDMA subcarrier resources were totally unusable at all times. In reality, even though roughly 15% of the useful subcarriers in each 10 MHz channel may overlap with the other channel, these resources are still available and usable most of the time for traffic channels. The overlapping subcarriers will simply experience more interference than the other subcarriers as load increases. Ultimately, there are two primary elements of WiMAX OFDMA system that will determine the level of performance degradation:

1) In PUSC (Permuted Usage of Subchannels), the OFDMA tones and the traffic subchannels are permuted among users and sectors—this frequency diversity creates a form of interference averaging. All users' data transmissions are spread over various frequencies, statistically lowering interference for everyone. This is a fundamental element of 802.16e OFDMA system design.

2) Advanced MAC schedulers will provide some ability to mitigate the negative effect of the overlap. MAC scheduling algorithms will allocate the OFDMA subchannels based on Signal-to-Noise Interference (SINR), Quality of Service (QoS) and other metrics. As subchannels in the overlap zone experience increased interference, the scheduler will avoid these resources where possible.

Essentially, the overlap zone increases the statistical chance of interference in the OFDMA resource pool. The performance degradation of the overlap scheme can be characterized as a reduction in average SINR. This SINR value will be a statistical function of subscriber/traffic loading. It is not constant throughout the cell; like all co-channel inter-cell interference, it will be felt at the cell-edge and other propagation “pockets” of low C/I in the radio network. The interference averaging and scheduling benefits described above will mitigate these affects, as they do for the system in general. When the system is lightly loaded, the impact of the overlapping channels is minimal. As load increases, the overlap zone is proportionally worse as it is exposed to the interference of both channels.

Adjacent Channel Performance (ACP)

Emission limits for OFDMA systems are controlled by standard specifications and regional regulations. Guard bands are used to provide protection for adjacent channels. Since the proposed scheme does not make use of the protection offered by the OFDMA guard subcarriers of the inner, overlapping edges the 10 MHz channel, adjacent channel performance issues must be carefully analyzed. If transmitters have a broad spectral mask, or receivers have poor filtering, then the interference could extend further into the overlapping channel than the previous analysis assumed.

Spectral mask performance is a function of design tradeoff decisions associated with the BS and mobile station (MS) transmitters and receivers; power amplifiers, filtering, antenna design, etc. TDD systems transmit and receive at different times utilizing synchronized timing, which by definition eliminates the two dominant interference scenarios that most FDD cellular systems face: BS to BS interference and MS to MS interference. Further, the BS radio equipment is usually higher performance than the corresponding MS radio equipment. This means that for OFDMA systems, Adjacent Channel Performance (ACP) would primarily only manifest itself as inter-cell, MS to MS interference at cell edge.

ACP system impact is a function of both unwanted transmitter emissions and the ability of the receiver filtering to reject them. Transmitter emissions are typically characterized in terms of Adjacent Channel Leakage Ratio (ACLR), which is the portion of the transmitter power that leaks into the receiver channel. This measurement is performed at the MS receiver where the BS transmitter transmits on 1 channel and the MS receiver measures leakage into the adjacent channel.

Receiver performance is typically characterized in terms of Adjacent Channel Selectivity (ACS), which measures the amount of power that is picked up by the overlap of the receiver bandwidth and the transmitter bandwidth. The diagram of FIG. 5 illustrates potential interference through both poor ACLR and non-ideal ACS. FIG. 5 is taken from a reference entitled Service Rules to Support Technology Neutral Allocations, FDD/TDD Coexistence, WiMAX Forum, January 2007. The top drawing in FIG. 5 illustrates the “ideal” transmitted spectrum as well as a “theoretical” actual transmitted spectrum. The top drawing of FIG. 5 also illustrates an “ideal” receive filter for an adjacent channel. The middle drawing of FIG. 5 illustrates adjacent channel interference due to out-of-band emissions from the theoretical actual transmitted spectrum. The transmitted spectrum mask illustrated in the bottom drawing of FIG. 5 is an envelope illustrating the maximum allowable out-of-band emissions. As will be discussed in greater detail below, actual performance characteristics are far better than the “theoretical” characteristics illustrated in FIG. 5.

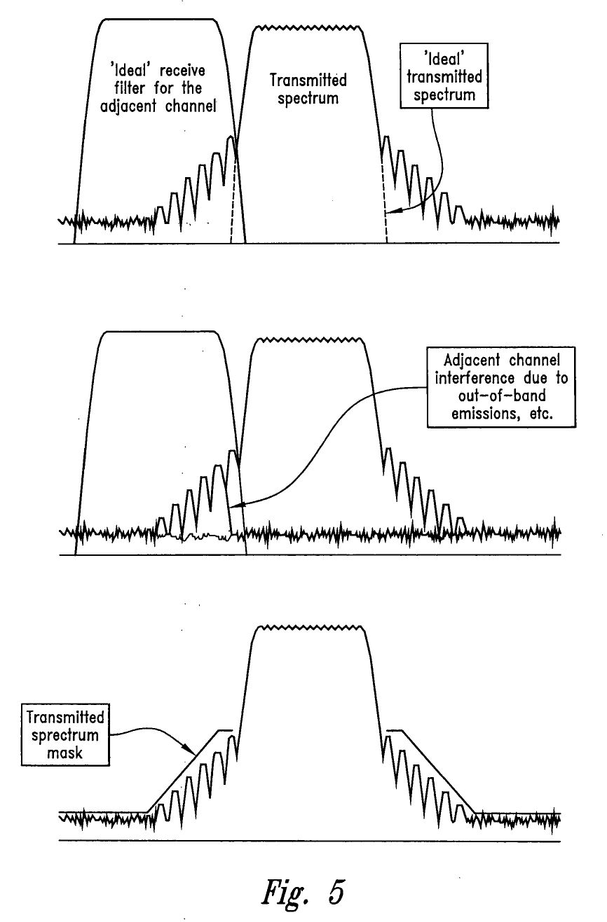

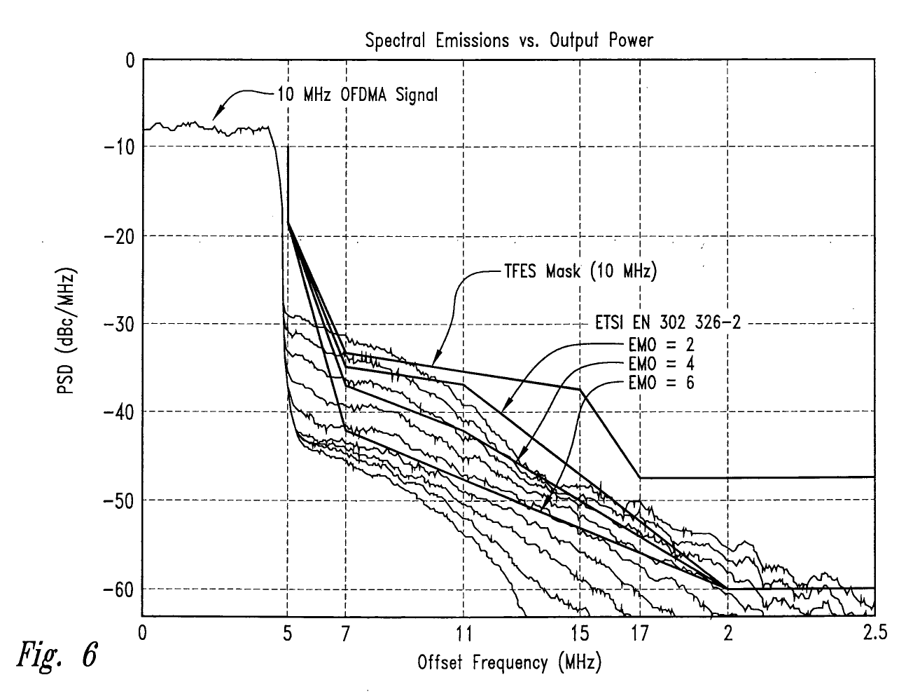

The plot of FIG. 6, taken from reference Inter-System MWA MS to MSA MS Coexistence Analysis in 3.5 GHz Band for Unsynchronized TDD Systems or TDD Adjacent to FDD Systems, CEPT, Electronics Communications Committee, Doc. SE19(06)70, November, 2006, shows spectrum data captured from a 3G WCDMA PA, using a 10 MHz OFDMA modulated signal, at different levels of output power. It also compares the spectrum data with the emission limits of several regulatory proposals.

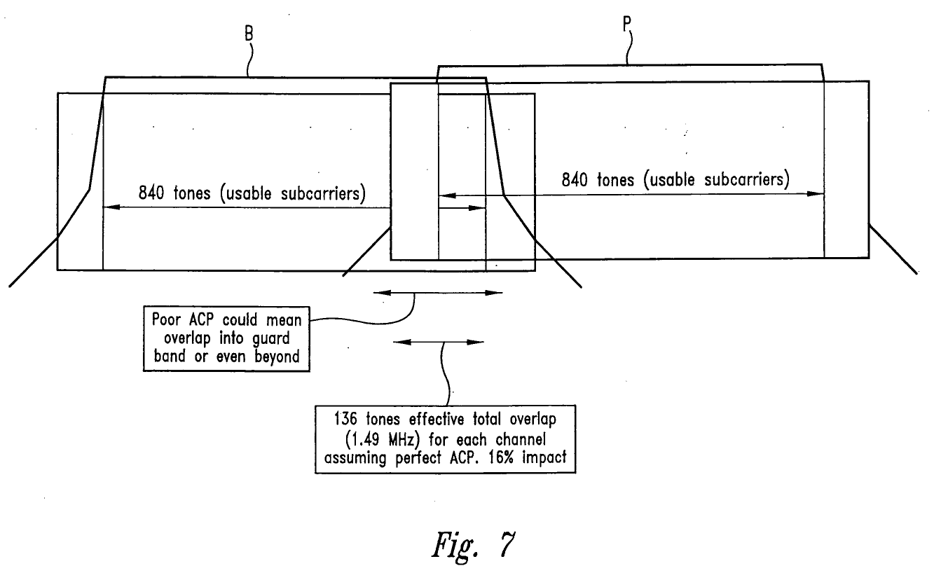

The diagram of FIG. 7 illustrates the potential impact of a worst case adjacent channel performance to the proposed overlapping channel scenario. The bold line B and the bold line P depict two overlapping channels, each with a very poor spectral mask that exceeds far beyond even the guard tones.

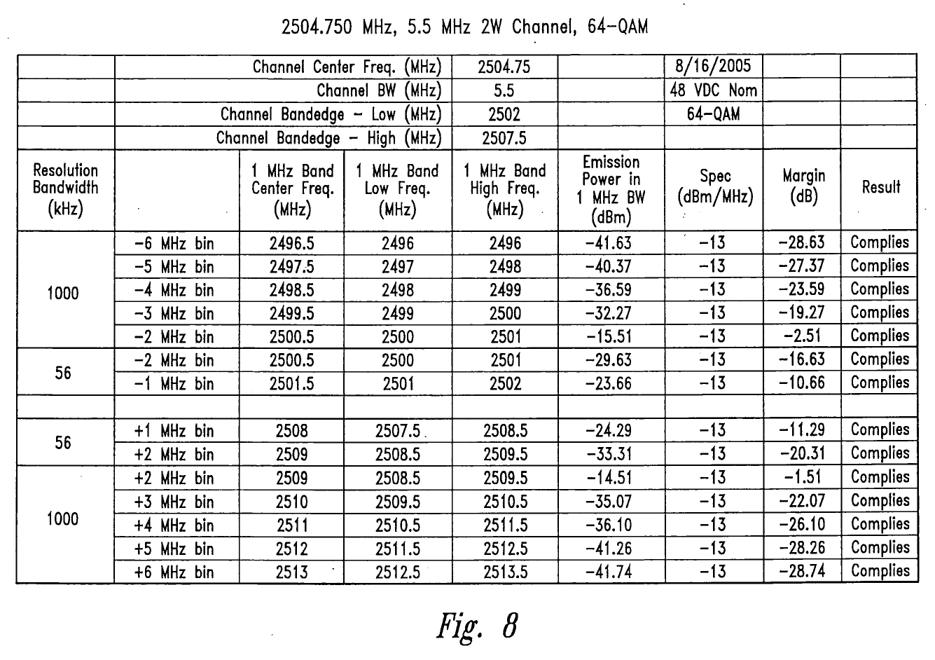

To examine real world ACP impact potential, spectral mask measurement data for two systems were analyzed. The first system is a pre-WiMAX NextNet Expedience OFDM base station. The table of FIG. 8, taken from a document referred to as Test Report FCC Part 27, FCC ID: PHX-MMDS-BASE2, NextNet Wireless, Inc, Oct. 11, 2005, shows an FCC Compliance test report for a 5.5 MHz OFDM channel using 64QAM modulation. FCC spectral mask requirements for the EBS/BRS band call for attenuation at band-edge of 43+10*log(P), which basically translates to −13 dBm. The spectral mask performance was excellent, well below the regulatory requirements. Measurements closest to the band edge (1 MHz bin) at the tightest resolution bandwidth (RBW) (i.e., 56 kHz) were an impressive −24.29 dBm.

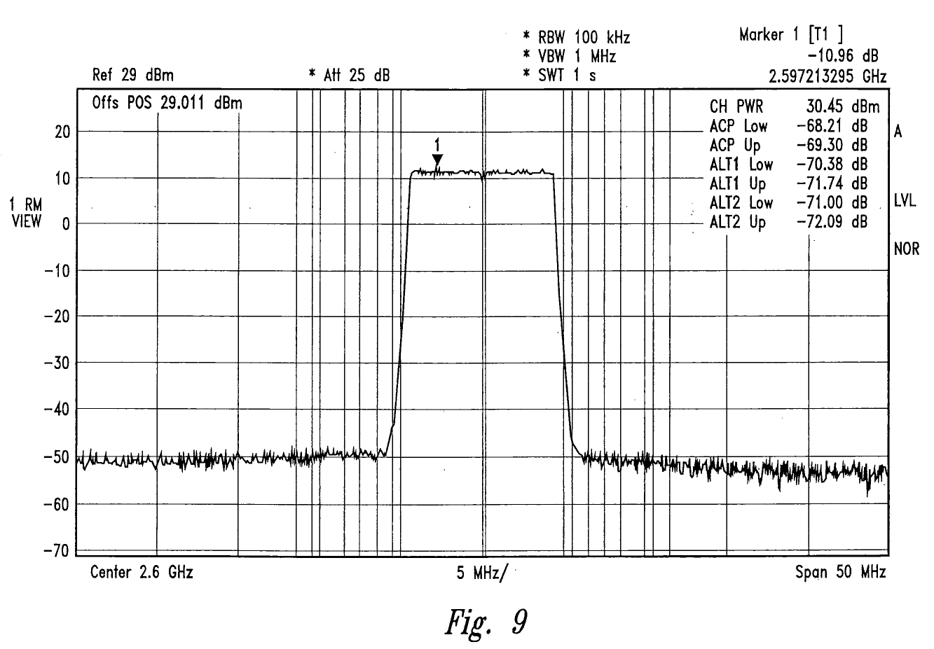

The second system was a Motorola WiMAX 802.16e DAP base station. The diagram of FIG. 9, taken from reference Out-of-Band Emissions Plot for 10 MHz Channel (DAP), Motorola Labs, Nov. 16, 2006, shows an out-of-band-emissions plot for a 10 MHz OFDMA channel, as measured on a prototype system in Motorola labs (100 kHz RBW with ACP measurements shown in 1 MHz measurement BW). Performance for this system is even better than the system measurements illustrated in FIG. 8; high and low ACP results are roughly −40 dBm. This plot is very useful as it depicts the precise channel configuration described in this paper. Analyzing the spectrum plot in detail, we can see that the occupied bandwidth does not go beyond the 9.18 MHz at significant power levels until nearly the full 10 MHz channel edge. The point where the channel emission exceeds the full 10 MHz channel bandwidth occurs at roughly −30 dBm.

This implies that ACP would not cause significant impact beyond the assumed overlap zone discussed in previous sections. The actual data illustrated in FIGS. 8-9 demonstrate performance that far exceeds the “theoretical” out-of-band emissions illustrated in FIG. 5. Thus, it is believed that channels can be tightly spaced, and even have some overlap, without serious impact on overall system performance. A proposal for such condensed frequency reuse is discussed below.

FCH and DL-MAP Considerations

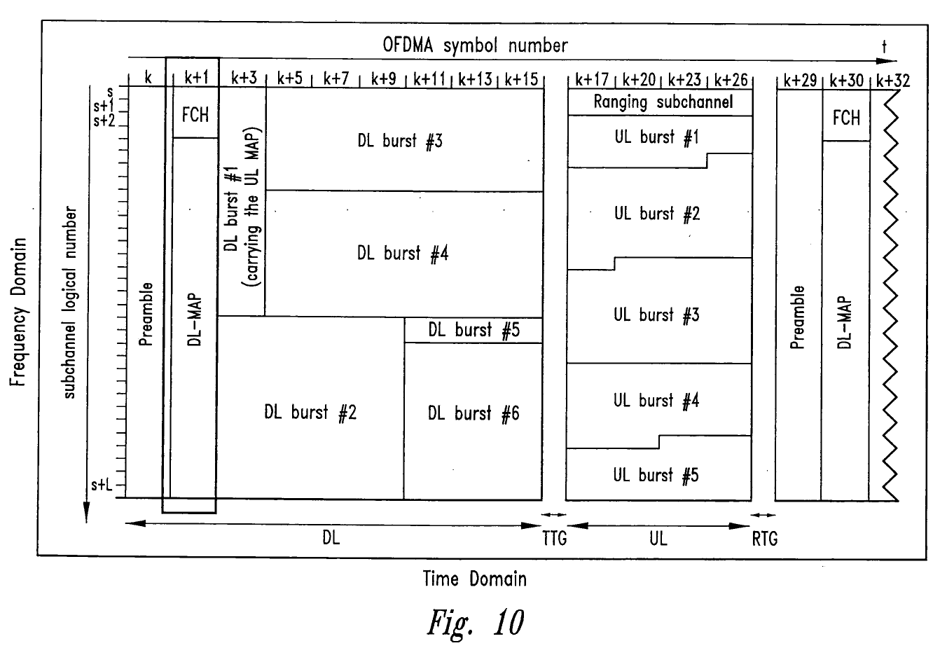

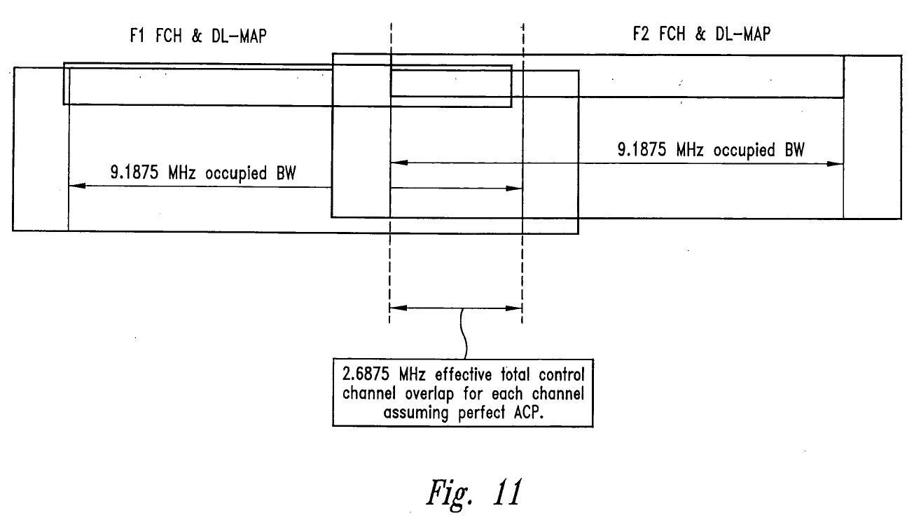

WiMAX has a unique and dynamic framing structure which depends on very reliable reception of control channel headers. Specifically, the Frame Control Header (FCH) and a downlink map (DL-MAP) are part of each and every WiMAX frame and must be decoded properly. Any potential to impact these control channels needs to be carefully analyzed. The diagram of FIG. 10 shows the 802.16e OFDMA TDD frame structure.

The FCH and DL-MAP are related—they occur in the first mandatory PUSC zone of each frame and together provide a mapping for the rest of the WiMAX frame structure. The FCH defines the format of the DL-MAP, and the DL-MAP in turn describes the zone/burst structure of the entire downlink and uplink portions of the frame. These portions of the frame must be decoded in order for the rest of the frame and traffic subchannels to be received.

In WiMAX, the term “slot” refers to a combination of subchannels in the frequency domain per OFDM symbol in the time domain. Subchannels, in turn are comprised of individual subcarrier frequencies. Subchannels are numbered logically—their grouping and physical subcarrier mappings are re-ordered according to complex permutation formulas on a per-symbol basis.

The FCH always occurs in the first 4 slots (OFDM symbols) of each frame. The DL-MAP is mapped to the first slots immediately following the FCH, and continuing to the next slots as necessary. What this means is that the FCH and DL-MAP will occupy all available data subchannels (frequencies) for at least the first the first 5 OFDM symbols (time domain). This exact total number of slots occupied depends on traffic load and type (i.e., more subscribers require more DL-MAP overhead); this value is typically modeled as 6-8 symbols.

Because FCH and DL-MAP will fully occupy all subcarriers in the first few slots of each frame, they represent a “fully loaded” system scenario—all subcarrier tones in these portions of the frame are guaranteed to always interfere with any other BS using the same subcarrier tones. For this reason, inter-sector and inter-BS co-channel FCH and DL-MAP interference are a very critical design aspect of the WiMAX network, essentially the limiting factor that determines cell radius.

How is the critical issue of FCH and DL-MAP performance potentially affected by the proposed condensed frequency reuse scheme? FIG. 10 highlights the FCH and DL-MAP, depicting the location of these regions in terms of subchannel (frequency) and time domains. The diagram of FIG. 11 crudely shows how the FCH and DL-MAP of both channels (i.e., F1 and F2) would overlap in the proposed scheme.

Because the FCH and first portions of the DL-MAP control channels occupy all subchannels on each WiMAX frame, the Interference, PUSC, and MAC scheduling benefits described above for traffic channel operation do not apply. Essentially the entire 2.6875 MHz of overlap region in the above diagram is potentially impacted for control channels.

In summary, downlink control channel interference is already the limiting design factor of WiMAX coverage. The overlapping channel scheme will increase control channel interference—essentially increasing the C/I requirement for cell design.

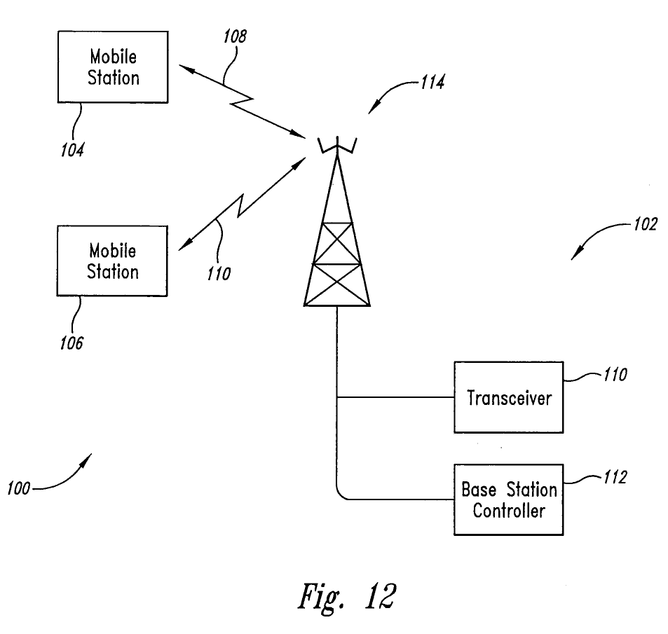

FIG. 12 illustrates an embodiment of a system 100 constructed in accordance with the present disclosure. A BS 102 communicate with a MS 104 and a MS 106 over wireless communication links 108 and 110, respectively. Although referred to herein as “Mobile Stations,” those skilled in the art will appreciate that a user can be in a fixed location, such as a home or office, and communicate with the BS 102 without physically changing location. The present disclosure is not limited to a MS that is actually moving.

The BS 102 comprises a transceiver 110 and a base station controller (BSC) 112. In an exemplary embodiment, the transceiver 110 is an OFDM transceiver. The transceiver 110 may be implemented as a separate transmitter and receiver. The BSC 112 controls operation of the BS 102 and, among other operations, selects the operational frequency and transmit power of the transceiver 110.

The BS 102 also has an antenna system 114. As those skilled in the art will appreciate, the BS 102 has a range of coverage that is typically divided into a plurality of sectors (e.g., three sectors). The antenna system 114 includes antenna elements that provide coverage for each of the plurality of sectors. The BS 102 may include a separate transceiver 110 for each sector. The multiple transceivers 110 may be controlled by a single BSC 112. The condensed frequency reuse implemented by the BS 102 is described above. That is, the transceivers 110 are programmed for operation using the condensed frequency reuse scheme described above. Operational details of the BS 102 is known in the art and need not be described in greater detail herein.

### Pro/Con Summary

The proposed condensed reuse configuration offers potentially significant benefits to a service provider. Below is a summary of the pros and potential cons, as currently understood:

### Pros:

Enables efficient deployment of 10 MHz channels using non-contiguous blocks of EBS/BRS spectrum based on a minimum of 33 MHz (six ITFS channels).
Maximizes full usage of operator spectrum.
Potentially provides a minimum of ˜23% spectral efficiency improvements over default WiMAX re-use schemes in markets with non-contiguous blocks of EBS/BRS spectrum (i.e. an A and C block).
For markets with contiguous but limited amounts of EBS/BRS spectrum (i.e. an A and B block), allows operator to run 10 MHz channels with similar and possibly better spectral efficiency than 5 MHz channels, while achieving better peak throughputs.
For mature markets, proposed 1/4/4 10 MHz system may provide similar or better performance than two overlaid 1/3/3 5 MHz systems, while enjoying the benefits of 10 MHz channels (higher peak data rates per user, single bandwidth devices, etc)—at much lower cost. Each site would have 4 sectors instead of 6, or 33% less sectors in the network.
Enables a range of scalable reuse deployment options:
a) Flexibility to address capacity requirements in a 1/3/3 system by stacking the 4^{th} channel on an as-needed basis at hotspot sectors.
b) Improved SINR gains by running adding a 4^{th} channel to the frequency plan in a network, creating a 1/3/4 system
   The combination of all above features would potentially provide a single, scalable solution for a service provider to deploy 10 MHz channels in all markets. Specifically, it would permit the operation of 10 MHz channels with a minimum cellular reuse 3, regardless of the amount or structure of available spectrum—the minimum requirement for operation is two non-adjacent EBR/BRS blocks. This would potentially eliminate the need for 5 MHz operation, and reduce any dependency on the dubious performance of WiMAX reuse 1.

### Cons

Potential adjacent channel performance issues.
DL-MAP interference increase due to frequency overlap may mitigate overall cost effectiveness of the solution in terms of cell radius.
Potential roaming complications. This proposal would make use of center frequencies that may be different among roaming partner companies. Currently, WiMAX standards do not specify roaming channel mechanisms. At some point a concept of shared channel configurations must be introduced, at which point presumably operators will develop a mechanism to synchronize mutual channel assignments, and this issue would be resolved. Previous cellular technologies have all dealt with these issues successfully exchanging information on their respective frequency plans.
Inter-band and intra-band roaming specifications are currently under development in the WiMAX Forum GRWG (Global Roaming Working Group). Theoretically, if the proposed is beneficial to one party it would offer just as much benefit for the roaming partner deploying within the same band. In fact, this could potentially even stimulate frequency “horse-trading” to maximize efficient deployments for both companies.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A method for channel allocation in a spectrum having predetermined bandwidth using an orthogonal frequency division multiplexing (OFDM) communication system, comprising:
allocating a plurality of channels each having an identical allocated bandwidth wherein the total bandwidth of the allocated channels exceeds the predetermined bandwidth; and
eliminating transmission of plurality of guard tones in each of the allocated channels, wherein each of the plurality of allocated channels has an overlap with an adjacent on of the plurality of allocated channels.

2. The method of claim 1 wherein the spectrum is an Educational Broadband Service (EBS)/Broadcast Radio Services (BRS) band and the plurality of allocated channels are adjacent channels in the EBS/BRS band.

3. The method of claim 1 wherein the spectrum is an Educational Broadband Service (EBS)/Broadcast Radio Services (BRS) band and the plurality of allocated channels are non-adjacent channels in the EBS/BRS band.

4. The method of claim 1 wherein one half of the guard tones for each allocated channel are positioned at each end of the allocated bandwidth.

5. The method of claim 1 wherein the predetermined bandwidth is 16.5 MHz and the plurality of allocated channels are two allocated channels each having an allocated bandwidth of 10 MHz.

6. The method of claim 5 wherein each of the 10 MHz channels have 1024 subcarriers and a total of 184 guard tone subcarriers.

7. The method of claim 6 wherein the 184 guard tone subcarriers are divided into 92 guard tone subcarriers at each end of the allocated bandwidth.

8. The method of claim 1 wherein the predetermined bandwidth is 33.0 MHz and the plurality of allocated channels are four allocated channels each having an allocated bandwidth of 10 MHz.

9. The method of claim 8 wherein each of the 10 MHz channels have 1024 subcarriers and a total of 184 guard tone subcarriers.

10. The method of claim 9 wherein the 184 guard tone subcarriers are divided into 92 guard tone subcarriers at each end of the allocated channel.

11. The method of claim 1 wherein the predetermined bandwidth is 16.5 MHz and the plurality of allocated channels are four allocated channels each having an allocated bandwidth of 5 MHz.

12. The method of claim 11 wherein each of the 5 MHz channels have 512 subcarriers and a total of 92 guard tone subcarriers.

13. The method of claim 12 wherein the 92 guard tone subcarriers are divided into 46 guard tone subcarriers at each end of the allocated channel.

14. The method of claim 1 wherein the predetermined bandwidth is 33.0 MHz and the plurality of allocated channels are eight allocated channels each having an allocated bandwidth of 5 MHz.

15. The method of claim 14 wherein each of the 5 MHz channels have 512 subcarriers and a total of 92 guard tone subcarriers.

16. The method of claim 15 wherein the 92 guard tone subcarriers are divided into 46 guard tone subcarriers at each end of the allocated channel.

17. A system for channel allocation in a spectrum having predetermined bandwidth using an orthogonal frequency division multiplexing (OFDM) communication system to communicate with a plurality of remote units, comprising:
a base station; and
a plurality of OFDM transceivers in the base station, each of the plurality of transceivers being allocated a channel on which to communicate with ones of the plurality of remote units with each channel having an identical allocated bandwidth wherein the total bandwidth of the allocated channels exceeds the predetermined bandwidth;
each of the plurality of transceivers being configured to eliminate a plurality of guard tones in each of the allocated channels prior to transmission, wherein each of the plurality of allocated channels has an overlap with an adjacent on of the plurality of allocated channels.

18. The system of claim 17 wherein the spectrum is an Educational Broadband Service (EBS)/Broadcast Radio Services (BRS) band and the channels allocated to the plurality of transceivers are adjacent channels in the EBS/BRS band.

19. The system of claim 17 wherein the spectrum is an Educational Broadband Service (EBS)/Broadcast Radio Services (BRS) band and the channels allocated to the plurality of transceivers are non-adjacent channels in the EBS/BRS band.

20. The system of claim 17 wherein the predetermined bandwidth is 16.5 MHz and the plurality of allocated channels are two allocated channels each having an allocated bandwidth of 10 MHz.

21. The system of claim 20 wherein each of the 10 MHz channels have 1024 subcarriers and a total of 184 guard tone subcarriers.

22. The system of claim 21 wherein the 184 guard tone subcarriers are divided into 92 guard tone subcarriers at each end of the allocated bandwidth.

23. The system of claim 17 wherein the predetermined bandwidth is 33.0 MHz and the plurality of allocated channels are four allocated channels each having an allocated bandwidth of 10 MHz.

24. The system of claim 23 wherein each of the 10 MHz channels have 1024 subcarriers and a total of 184 guard tone subcarriers.

25. The system of claim 24 wherein the 184 guard tone subcarriers are divided into 92 guard tone subcarriers at each end of the allocated channel.

26. The system of claim 17 wherein the predetermined bandwidth is 16.5 MHz and the plurality of allocated channels are four allocated channels each having an allocated bandwidth of 5 MHz.

27. The system of claim 26 wherein each of the 5 MHz channels have 512 subcarriers and a total of 92 guard tone subcarriers.

28. The system of claim 27 wherein the 92 guard tone subcarriers are divided into 46 guard tone subcarriers at each end of the allocated channel.

29. The system of claim 17 wherein the predetermined bandwidth is 33.0 MHz and the plurality of allocated channels are eight allocated channels each having an allocated bandwidth of 5 MHz.

30. The system of claim 29 wherein each of the 5 MHz channels have 512 subcarriers and a total of 92 guard tone subcarriers.

31. The system of claim 30 wherein the 92 guard tone subcarriers are divided into 46 guard tone subcarriers at each end of the allocated channel.
